(19) United States
(12) Patent Application Publication
(10) Pub. No.: US 2015/0034751 A1
(43) Pub. Date: Feb. 5, 2015

(54) Yarn Tensioner

(71) Applicant: Uster Technologies AG, Uster (CH)

(72) Inventors: Benno Grob, Chiang Mai (TH); Martin Kuster, Eschenbach (CH)

(73) Assignee: USTER TECHNOLOGIES AG, Uster (CH)

(21) Appl. No.: 14/383,041

(22) PCT Filed: Mar. 1, 2013
(86) PCT No.: PCT/CH2013/000033

§ 371 Date: Sep. 4, 2014

(30) Foreign Application Priority Data
Mar. 21, 2012 (CH) 399/12

(51) Int. Cl. B65H 59/22; B08B 5/02

(52) U.S. Cl. CPC B65H 59/225; B08B 5/02
USPC 242/150 R; 134/37

(57) ABSTRACT

A combination of a disc-type yarn tensioner is proposed, comprising a pneumatic cleaning device, which is fixedly assigned thereto. The disc-type yarn tensioner comprises an axle on which two brake plates are rotatably mounted by means of one rotary bearing each. It further comprises a pressure mechanism for applying axial pressure forces to the brake plates, which pressure forces press the brake plates against each other. The pneumatic cleaning device comprises at least one nozzle whose flow axis is directed from the outside substantially towards one of the rotary bearings. The compressed air flow exiting from the nozzle cleans the disc-type yarn tensioner. It is thus ensured that the rotary bearings of the brake plates accumulate less dirt and the rotary movement of the brake plates is braked with the intended braking force.

### FIELD

This application claims rights and priority on prior pending PCT application PCT\CH2013\000033 filed 2013 Mar. 1 and Swiss patent application 399/12 filed 2012 Mar. 21. The present invention lies in the field of handling yarn. It relates to a combination of a disc-type yarn tensioner with an associated cleaning device and a method for cleaning a disc-type yarn tensioner according to the preambles of the independent claims.

### INTRODUCTION

A disc-type yarn tensioner comprises two brake plates, which are rotatably mounted on a common axle and which are impinged with axial pressure forces in such a way that the yarn to be braked or tensioned is clamped between them. The brake plates exert a frictional force on the yarn which tensions it.

Abraded matter is produced as a result of the continuous friction between the brake plates and the yarn, which abraded matter is deposited, among other things, on parts of the yarn tensioner. Dirt accumulation on the yarn tensioners can lead to malfunctions. DE-42'13'859 A1 proposes to fixedly assign a pneumatic cleaning device to each yarn clamping apparatus on a bobbin creel. The pneumatic cleaning device cleans the yarn clamping apparatus with a compressed air flow. The compressed air flow is directed between the jaws of the clamping apparatus and thus keeps the region between the jaws clean. The blowing can occur continuously or intermittently.

U.S. Pat. No. 2,930,543 A discloses a disc-type yarn tensioner in a yarn winding machine. The periphery of the disc-type yarn tensioner is partly surrounded by a semicircular tube which comprises a plurality of nozzles directed towards the disc-type yarn tensioner. The disc-type yarn tensioner can be opened in that the two brake plates are moved away from each other with an opening mechanism. Air is injected from the nozzles into the interior of the disc-type yarn tensioner in the open state, i.e. between the brake plates, in order to remove dirt accumulations from the interior.

DE-93'11'971 U1 relates to a disc-type yarn tensioner with a vertical hollow plate axle which supports two brake plates. Its object is to prevent interior accumulation of dirt in the hollow space of the hollow plate axle. In order to achieve this object, the plate axle and the bearing plate which accommodates the plate axle comprise an air channel, which is connected on the one hand to a compressed air source and on the other hand to fiber dust collecting points in the region of the bottom plate. The air channel can be a sealed annular groove of the plate axle. The air is blown through the air channel beneath the bottom plate in such a way that fiber dust is blown away which could not be removed by global blasting of the disc-type yarn tensioner from above or below.

### SUMMARY

It is an object of the present invention to further improve the known disc-type yarn tensioners by using a suitable cleaning device.

This and other objects are achieved by the combination and the method in accordance with the invention, as defined in the independent claims. Advantageous embodiments are provided in the dependent claims.

It has been noticed that it is advantageous to brake the rotational movement of the braking plates of a disc-type yarn tensioner in such a way that they still rotate, but not too lightly. For this purpose, the braking force acting on the braking plates must be set correctly. The braking force can change by the accumulation of dirt, so that the disc-type yarn tensioner no longer operates as intended. The braking plates will then not rotate at all, or only to a limited extent or too lightly. On the basis of this realization, the invention is based on the idea to fixedly assign a cleaning device to a disc-type yarn tensioner, which cleaning device externally cleans the brake plates and its common axle by a compressed air flow. It is thus ensured that the rotary bearings of the brake plates will accumulate less dirt and the rotational movement of the brake plate is braked with the intended braking force.

The invention accordingly relates to a combination of a disc-type yarn tensioner with a pneumatic cleaning device which is fixedly assigned thereto and is spaced therefrom. The disc-type yarn tensioner comprises an axle on which two brake plates are rotatably mounted by means of one rotary bearing each. It further comprises a pressure mechanism for applying axial pressure forces to the brake plates, which press the brake plates against each other. The pneumatic cleaning device comprises at least one nozzle spaced from the disc-type yarn tensioner for blowing air against the disc-type yarn tensioner from the outside. The flow axis of the at least one nozzle is directed from the outside substantially towards one of the rotary bearings.

The designation “outside” relates in this specification to those sides of the brake plates which face away from each other and thus do not press against each other. Accordingly, the yarn to be tensioned extends on the “inside,” i.e. between the brake plates. With respect to a possible hollow axle, the designation “outside” relates to the surface which is farther away from the center of the hollow axle.

The pneumatic cleaning device can comprise a base body which comprises a compressed air connection having at least one nozzle and a pneumatic connecting line between the compressed air connection and the at least one nozzle.

In one embodiment, the pneumatic cleaning device comprises two nozzles which are spaced from the disc-type yarn tensioner, whose flow axes are directed from the outside substantially towards one each of the rotary bearings. The base body then extends in the axial direction and contains the two nozzles, wherein the two nozzles have an axial distance of 15 mm to 20 mm from each other.

The disc-type yarn tensioners and the pneumatic cleaning device are, in one embodiment, attached to a common carrier device. A measuring head for checking a yarn tensioned by the disc-type yarn tensioner can further be attached to the carrier device.

The method in accordance with the invention is used for cleaning the disc-type yarn tensioner. The disc-type yarn tensioner comprises an axle on which two brake plates are rotatably mounted by means of one rotary bearing each. It further comprises a pressure mechanism for applying axial pressure forces to the brake plates, which pressure forces press the brake plates against each other. The disc-type yarn tensioner is cleaned by at least one compressed air flow which is directed from the outside against said tensioner and which propagates freely in an ambient environment of the disc-type yarn tensioner. The direction of flow of the at least one compressed air flow is directed from the outside substantially towards one of the rotary bearings.

A direction of flow of the at least one compressed air flow, in one embodiment, comprises a first component which is directed towards an exterior side of the axle and a second component which is directed towards an exterior side of one of the brake plates.

The compressed air flow can be continuous or intermittent.

In one embodiment, the disc-type yarn tensioner is cleaned by two compressed air flows which propagate freely in the ambient environment of the disc-type yarn tensioner, whose directions of flow are directed from the outside substantially towards one each of the rotary bearings.

### DRAWINGS

An embodiment of the invention is explained in closer detail below by reference to the enclosed drawings, wherein:

FIG. 1 shows a perspective view of a disc-type yarn tensioner and a pneumatic cleaning apparatus in accordance with an embodiment of the invention, which is associated therewith.

FIG. 2 shows a cleaning apparatus in accordance with an embodiment of the invention in a front view.

FIG. 3 shows a part of FIG. 1, namely (a) in a front view and (b) in a side view.

### The drawings are not shown all on the same scale.

### DESCRIPTION

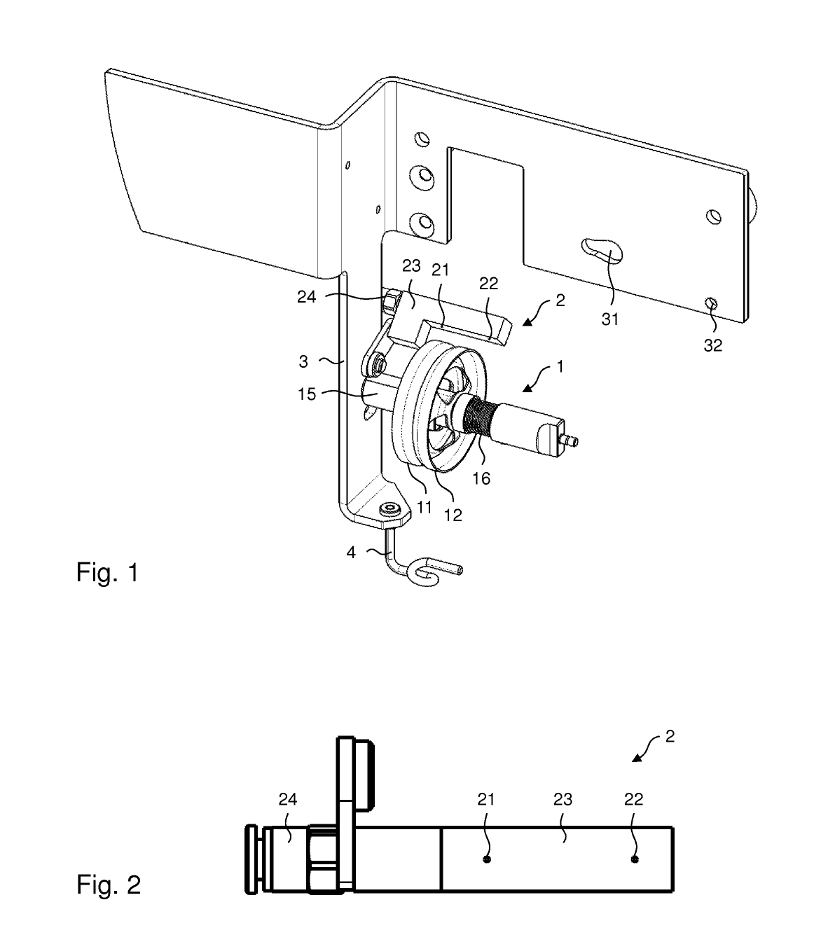

FIG. 1 shows a disc-type yarn tensioner 1 in accordance with an embodiment of the invention, together with a pneumatic cleaning apparatus 2, which is assigned thereto and is spaced therefrom. The disc-type yarn tensioner 1 comprises an axle 15 in the form of a pin, on which two brake plates 11, 12 are rotatably mounted by one rotary bearing 13, 14 each. A helical compression spring 16 that is placed over the axle 15 applies an axial pressure force to one of the brake plates 12, and a respective counterforce acts on the other brake plate 11, so that the brake plates 11, 12 are pressed against each other. The yarn (not shown) to be tensioned is clamped and drawn off between the brake plates 11, 12. The rotary movements of the brake plates 11, 12 are braked and exert a frictional force on the yarn, which tensions the same. It is desirable for the brake force acting on the brake plates 11, 12 to be set correctly, such that the setting is not unduly impaired by the accumulation of dirt in the rotary bearings 13, 14.

A cleaning device 2 is fixedly assigned to the disc-type yarn tensioner 1 for cleaning the same. The cleaning device 2 is shown in FIG. 2 alone. It comprises a base body 23 with a compressed air connection 24. The base body 23 extends in the axial direction and contains two nozzles 21, 22 spaced from the disc-type yarn tensioner 1 for blowing towards the disc-type yarn tensioner 1 from the outside. The nozzles 21, 22 are connected to the compressed air connection 24 via a pneumatic connecting line (not shown) extending in the interior of the base body 23. The two nozzles 21, 22 are arranged on the same surface of the base body 23, which faces the disc-type yarn tensioner 1 and have an axial distance of 15 to 20 mm, e.g. 18 mm, from each other.

The disc-type yarn tensioner 1 and the pneumatic cleaning device 2 are attached to a common carrier device 3, as shown in FIG. 1. The carrier device 3 is arranged as a suitably shaped sheet metal, which can be fixed to a winding head of a bobbin winding machine. A yarn guide element 4 is also attached to the carrier device 3, which guide element is used to supply the yarn in the correct position to the disc-type yarn tensioner 1. A measuring head (not shown) for testing a yarn tensioned by the disc-type yarn tensioner 1 can be attached to the carrier device 3 by means of suitable connections, for which purpose through-holes 31, 32 are provided in the carrier device 3.

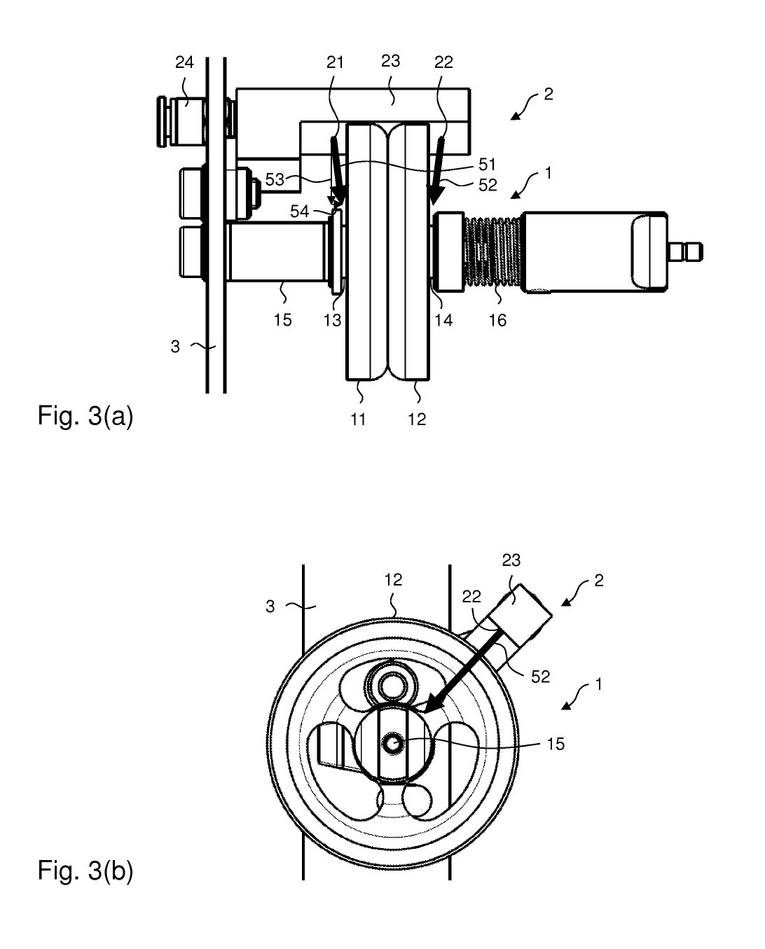

The flow axes of the nozzles 21, 22, which are spaced from the disc-type yarn tensioner 1, are directed from the outside substantially against one each of the rotary bearings 13, 14. In FIG. 3, the arrows 51, 52 indicate the flow directions of the compressed air flows ejected by the nozzles 21, 22. It is understood that this only represents a simplification, because not all air particles ejected by the nozzles 21, 22 will have the same direction of movement 51 and 52 as shown in the drawing. The arrows 51, 52 show the desired main directions of flow and can also be understood as extensions of the flow axes of the nozzles 21, 22. The direction of flow 51 of a respective compressed air flow is oblique in the sense that it comprises a first component 53, which is directed towards an exterior side of the axle 15, and a second component 54, which is directed towards an exterior side of the respective brake plate 11. In the embodiment of FIG. 3, the first component 53 is somewhat larger than the second component 54.

The distance of a nozzle 21, 22 from the jacket surface of the respective brake plate 11, 12 is 2 to 10 mm for example, e.g. 5 mm, and the distance of a nozzle 21, 22 from the surface of the axle 15 is 15 to 30 mm for example, e.g. 20 mm.

It is understood that the present invention is not limited to the embodiments as discussed above. The person skilled in the art will be able to derive further variants with knowledge of the invention, which shall also belong to the subject matter of the present invention.

### LIST OF REFERENCE NUMERALS

1 Disc-type yarn tensioner
11, 12 Brake plate
13, 14 Rotary bearing
15 Axle
16 Compression spring
2 Cleaning device
21, 22 Nozzles
23 Base body
24 Compressed air connection
3 Carrier device
31, 32 Through-holes
4 Yarn guide element
51, 52 Flow directions, flow axes
53, 54 Components of the direction of flow

1. An apparatus comprising:
a combination of a disc-type yarn tensioner and a pneumatic cleaning device that is fixedly assigned thereto and spaced therefrom,
the disc-type yarn tensioner comprises an axle on which two brake plates are rotatably mounted by one rotary bearing each, and a pressure mechanism for applying axial pressure forces to the brake plates, which pressure forces press the brake plates against each other, and
the pneumatic cleaning device comprises at least one nozzle spaced from the disc-type yarn tensioner for blowing air against the disc-type yarn tensioner from the outside, wherein the flow axis of the at least one nozzle is directed from the outside towards substantially one of the rotary bearings.

2. The apparatus according to claim 1, wherein the pneumatic cleaning device comprises a base body having a compressed air connection that contains at least one nozzle and a pneumatic connecting line between the compressed air connection and the at least one nozzle.

3. The apparatus according to claim 1, wherein the pneumatic cleaning device comprises two nozzles that are spaced from the disc-type yarn tensioner and whose flow axes are directed from the outside substantially towards one each of the rotary bearings.

4. The apparatus according to claim 3, wherein the base body extends in the axial direction and contains the two nozzles, and wherein the two nozzles have an axial distance of 15 to 20 mm from each other.

5. The apparatus according to claim 1, wherein the disc-type yarn tensioner and the pneumatic cleaning device are attached to a common carrier device.

6. The apparatus according to claim 5, wherein a measuring head for testing a yarn tensioned by the disc-type yarn tensioner is further attached to the carrier device.

7. A method for cleaning a disc-type yarn tensioner, the method comprising the steps of:
providing an axle on which two brake plates are rotatably mounted by means of one rotary bearing each,
providing a pressure mechanism for applying axial pressure forces to the brake plates, which pressure forces press the brake plates against each other,
directing at least one compressed air flow from the outside towards the tensioner such that the at least one compressed air flow propagates freely in an ambient environment of the disc-type yarn tensioner, and
the direction of flow of the at least one compressed air flow is directed from the outside substantially towards one of the rotary bearings.

8. The method according to claim 7, wherein a direction of flow of the at least one compressed air flow comprises a first component that is directed towards an exterior side of the axle and a second component that is directed towards an exterior side of one of the brake plates.

9. The method according to claim 7, wherein the compressed air flow is at least one of continuous and intermittent.

10. The method according to claim 7, wherein the disc-type yarn tensioner is cleaned by two compressed air flows propagating freely in the ambient environment of the disc-type yarn tensioner, whose directions of flow are directed from the outside substantially towards one each of the rotary bearings.
